(19) United States
(12) Patent Application Publication
(10) Pub. No.: US 2026/0343606 A1
(43) Pub. Date: Oct. 29, 2026

(54) FRAME TO END TRANSMISSION OPPORTUNITIE DURING DYNAMIC SUBBAND OPERATION

(71) Applicant: Nokia Technologies Oy, Espoo (FI)

(72) Inventors: Klaus Franz DOPPLER, Sunnyvale, CA (US); Kerstin JOHNSSON, Sunnyvale, CA (US); Behnam DEZFOULI, Sunnyvale, CA (US); Prabodh VARSHNEY, Dallas, TX (US); Salvatore TALARICO, Sunnyvale, CA (US)

(21) Appl. No.: 19/188,904

(22) Filed: Apr. 24, 2025

(51) Int. Cl. H04W 74/0816; H04W 72/0453; H04W 74/08

(52) U.S. Cl. CPC H04W 74/0816; H04W 72/0453; H04W 74/0866

(57) ABSTRACT

Example embodiments of the present disclosure are directed to frame to end a TXOP during dynamic subband operation. A method includes receiving, from a second apparatus in the wireless network, a first frame comprising information addressed to one or more apparatuses that are in a dynamic subband operation within a transmission opportunity, TXOP; and switching from a first subband to a second subband based on the reception of the first frame.

### FIELD

Various example embodiments of the present disclosure generally relate to the field of telecommunication and in particular, to methods, devices, apparatuses and computer readable storage medium for frame to end a transmission opportunity (TXOP) during dynamic subband operation (DSO).

### BACKGROUND

A communication network may serve as a facility that enables communication between two or more communication devices or provides communication devices access to a data network. A wireless communication network is one example of a communication network. The communication network may operate in accordance with standards such as those provided by the Institute for Electrical and Electronics Engineers (IEEE). Examples of standards provided by IEEE are the so-called IEEE 802.11 standards or Wireless Fidelity (Wi-Fi) standards for Wi-Fi generations such as 802.11n, 802.11ac, 802.11ax, 802.11be, and 802.11bn, etc.

### SUMMARY

In a first aspect of the present disclosure, there is provided a first apparatus. The first apparatus comprises at least one processor; and at least one memory storing instructions that, when executed by the at least one processor, cause the first apparatus in a wireless network to: receive, from a second apparatus in the wireless network, a first frame comprising information addressed to one or more apparatuses that are in a dynamic subband operation within a transmission opportunity, TXOP; and switch from a first subband to a second subband based on the reception of the first frame.

In a second aspect of the present disclosure, there is provided a second apparatus. The second apparatus comprises at least one processor; and at least one memory storing instructions that, when executed by the at least one processor, cause the second apparatus in a wireless network, to: transmit, to a first apparatus, a first frame comprising information addressed to one or more apparatuses that are in a dynamic subband operation within a transmission opportunity, TXOP; and transmit a second frame to end the TXOP.

In a third aspect of the present disclosure, there is provided a method. The method comprises: receiving, from a second apparatus in the wireless network, a first frame comprising information addressed to one or more apparatuses that are in a dynamic subband operation within a transmission opportunity, TXOP; and switching from a first subband to a second subband based on the reception of the first frame.

In a fourth aspect of the present disclosure, there is provided a method. The method comprises: transmitting, to a first apparatus, a first frame comprising information addressed to one or more apparatuses that are in a dynamic subband operation within a transmission opportunity, TXOP; and transmitting a second frame to end the TXOP.

In a fifth aspect of the present disclosure, there is provided a first apparatus. The first apparatus comprises means for receiving, from a second apparatus in the wireless network, a first frame comprising information addressed to one or more apparatuses that are in a dynamic subband operation within a transmission opportunity, TXOP; and means for switching from a first subband to a second subband based on the reception of the first frame.

In a sixth aspect of the present disclosure, there is provided a second apparatus. The second apparatus comprises means for transmitting, to a first apparatus, a first frame comprising information addressed to one or more apparatuses that are in a dynamic subband operation within a transmission opportunity, TXOP; and means for transmitting a second frame to end the TXOP.

In a seventh aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of dynamic subband operation (DSO);

FIG. 3 illustrates a signaling chart of a transmission of frame to end TXOP in accordance with some example embodiments of the present disclosure;

FIG. 4 illustrates a schematic diagram of an example of frame format in accordance with some example embodiments of the present disclosure;

FIG. 5 illustrates a signaling chart of a transmission of frame to end TXOP in accordance with some other example embodiments of the present disclosure;

FIG. 6 illustrates a schematic diagram of an example of frame format in accordance with some example embodiments of the present disclosure;

FIG. 7 illustrates a schematic diagram of a transmission of frame to end TXOP in accordance with some example embodiments of the present disclosure;

FIG. 8 illustrates a flowchart of a method implemented at a first apparatus in accordance with some example embodiments of the present disclosure;

FIG. 9 illustrates a flowchart of a method implemented at a second apparatus in accordance with some example embodiments of the present disclosure;

FIG. 10 illustrates a flowchart of a method implemented at a first apparatus in accordance with some example embodiments of the present disclosure;

FIG. 11 illustrates a flowchart of a method implemented at a second apparatus in accordance with some example embodiments of the present disclosure;

FIG. 12 illustrates a simplified block diagram of a device that is suitable for implementing example embodiments of the present disclosure; and

FIG. 13 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,”…, etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

WLAN, commonly implemented under IEEE 802.11 standards (i.e., Wi-Fi), enables high-speed wireless connectivity across diverse environments, including residential, enterprise, industrial, and public spaces. These networks support bidirectional communication between STAs, facilitating data, voice, and multimedia transmission.

A STA refers to an entity that can be addressed uniquely (i.e., it has a single and unique medium access control (MAC) address) and that provides 802.11 physical (PHY) and MAC functions. STAs can communicate with each other directly. A set of STAs that can communicate with each other form a Basic Service Set (BSS), and the area that their signals cover forms a Basic Service Area (BSA). A STA may be implemented in an AP or implemented as a non-AP STA depending on its functions.

An AP refers to a device in WLAN that provides wireless devices with wireless access to a wired or a wireless network. The AP may serve as a hub for the WLAN and may be regarded as a network device implemented in WLAN. The AP may be responsible for sending and receiving wireless signals, network connection management and data forwarding. By way of example rather than limitation, an AP may also be referred to as a Wi-Fi router, a radio router, a radio transceiver, a transceiver function (“TF”), a wireless access node, a wireless switch, an access bridge, or some other terminology, and so forth.

A non-AP STA refers to a wireless device that connects to an AP to access the network. A non-AP STA serves as a user of the WLAN and may be regarded as a terminal device implemented in WLAN. Non-AP STAs are typically end-user devices that do not provide access to other devices but rather consume network services. If a non-AP STA has the Wi-Fi hotspot on, it may also be referred to as mobile AP and can provide services to other non-AP STA. A non-AP STA may also provide services to other non-AP STA, for example, with Wi-Fi Direct, peer to peer (P2P) or Wi-Fi Aware networking. By way of example rather than limitation, a non-AP STA may also be referred to as a STA for simplicity, or a wireless client, a client STA, a subscriber STA, a subscriber unit, a remote STA, a remote terminal, an end device, an access terminal, a terminal device, a mobile station, a user terminal, a user agent, a user device, user equipment, or some other terminology. Examples of the terminal devices may be implemented as a non-AP STA if located in a WLAN, and duplications thereof will be omitted.

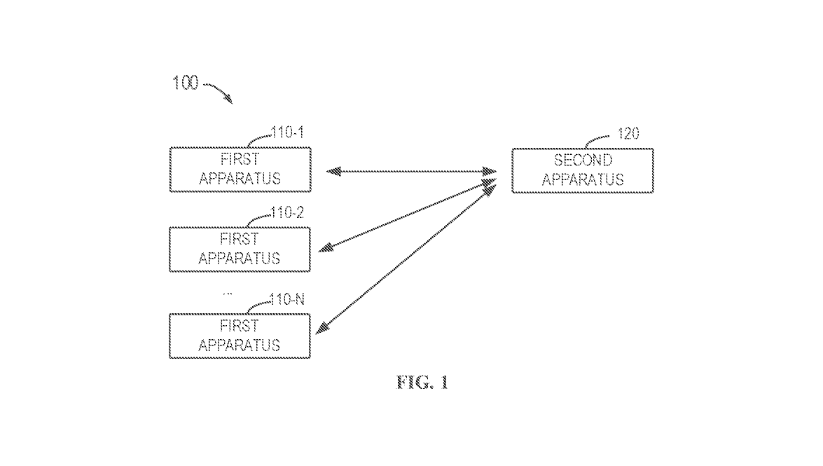

FIG. 1 illustrates an example communication environment 100 in which example embodiments of the present disclosure can be implemented. In the communication environment 100, a plurality of Wi-Fi devices can communicate with each other. The plurality of Wi-Fi devices may include one or more stations such as a first apparatus 110-1, first apparatus 110-2, …, first apparatus 110-m (individually or collectively referred to as first apparatus 110). One or more first apparatuses 110 may be in a dynamic subband operation. The plurality of Wi-Fi devices may further include a second apparatus 120. The plurality of Wi-Fi devices may communicate with each other.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the communication environment 100.

In some example embodiments, a transmission direction from the second apparatus 120 to the first apparatus 110 is referred to as a downlink (DL), while a transmission direction from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), comprising, but not limited to, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As mentioned above, examples of standards provided by IEEE are the so-called IEEE 802.11 standards or Wireless Fidelity (Wi-Fi) standards for Wi-Fi generations such as 802.11n, 802.11ac, 802.11ax, 802.11be, and 802.11bn, etc. 802.11bn is the next generation Wi-Fi (also referred to as Wi-Fi 8) under development in 802.11. One of the topics under consideration is the low latency (LL) support, i.e., delivering frames with low latency for AP and non-AP STA.

TXOP refers to a time duration of a STA (AP or non-AP STA), in which it can transmit frames. When the STA gains access to the channel (based on enhanced distributed channel access (EDCA)), it becomes a TXOP holder. During a TXOP the STA can transmit in UL OFDMA after receiving a trigger frame with resource allocation. The AP may share the TXOP with another STA using multi-user request to send (MU-RTS) transmission opportunity sharing (TXS) frames. A STA that receives frames from the TXOP is referred to as TXOP responder. There may be more than one STA in OFDMA that can act as TXOP responder.

In basic service sets (BSSs) with large operating bandwidths (BWs) (e.g., 320 MHz), DSO improves an ability of AP to use the entire BW despite having associated STAs with significantly smaller operating BWs. It accomplishes this by enabling an AP to inform certain associated STAs to move to other parts of the BSS operating BW for the purposes of data exchange.

For example, if STAs associated with the AP are all limited to an operating BW of 40 MHz, 280 MHz of its operating BW would sit idle. However, with DSO, when an AP captures all/parts of its operating BW for the period of a TXOP, it can request that some of its STAs move to other parts of the BSS operating BW for that TXOP.

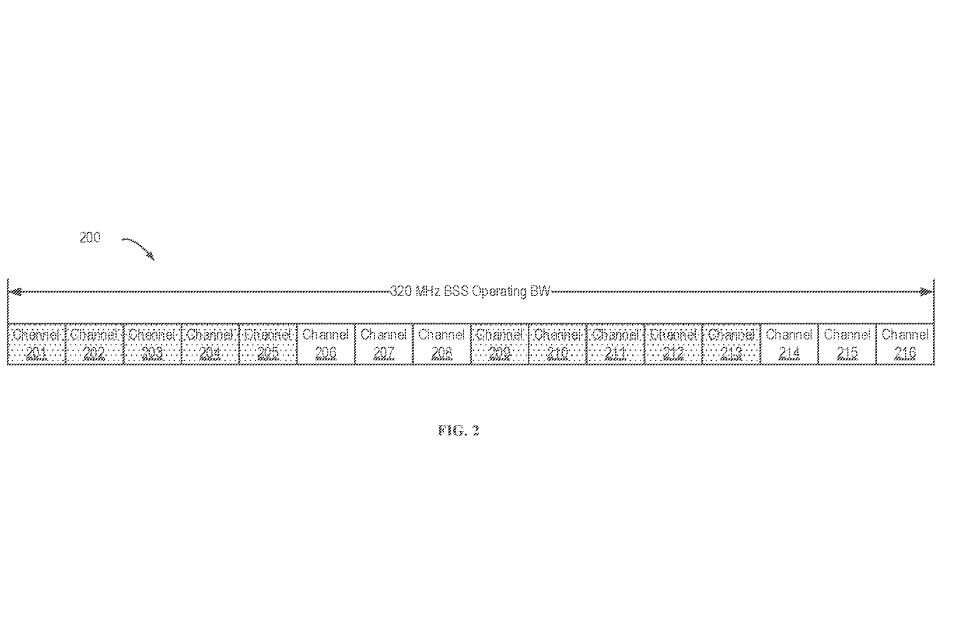

FIG. 2 illustrates a schematic diagram of DSO. As shown in FIG. 2, there may be 16 channels (i.e., channels 201, 202, 203, 204, 205, 206, 207, 208, 209, 210, 211, 212, 213, 214, 215 and 216) over the total BW. The channels 201, 202, 203, 204, 205, 209, 210, 211, 212 and 213 have been “captured” by the AP for the upcoming TXOP. With DSO, the AP can assign various contiguous sets of channels to its associated STAs. Note that the total BW of contiguous channels an AP assigns a STA for that TXOP is less than or equal to the STA’s operating BW.

Clearly, being able to allocate STAs with limited operating BW across the BSS’s larger operating BW increases channel utilization, thereby increasing BSS throughput and decreasing BSS latencies. However, moving STAs between their primary locations and other parts of the BSS’s operating BW does incur overhead due to the required switching times (which can range up to 256 us each way). Nevertheless, the performance gains in throughput and latency outweigh the losses due to overhead.

Since an AP typically only has one radio for UL and DL communication on a given band, it can only do one at a time. Thus, when the AP moves STAs to DSO locations, they are all in DL or UL mode at the same time, or frames will be lost. The AP uses OFDMA for downlink transmissions and trigger based OFDMA for UL transmissions.

For this reason, current versions of DSO require that the AP initiate/control the transition of STAs to DSO bands for a given TXOP, and that all STAs return to their primary band at the end of the TXOP. However, due to different switching times of STAs associated with the AP, many of the STA will not be back on the primary channel right after the frame to end the give TXOP and may even lose medium synchronization if the switching time is longer than 72us.

In accordance with some example embodiments of the present disclosure, there is provided a solution for switching back to a primary subband during DSO. Specifically, an AP transmits, to a STA, a frame to end a TXOP that includes an intermediate frame check sequence (FCS) field and a padding field. Using the padding, the STA can already switch back to the primary channel after decoding the frame until the intermediate frame check sequence. In this way, the STA can switch back to the primary subband in time and still be synchronized to the medium. Alternatively, the AP transmits, to the STA, a first frame to end the TXOP followed by a second frame to end the TXOP that is broadcasted to all STAs. In this way, the STA can switch back to the primary subband in time and still be synchronized to the medium, which allows the DSO STAs to participate in channel contention or to receive the next frame from the AP.

Example embodiments of the present disclosure will be described in detail below with reference to the accompanying drawings.

FIG. 3 illustrates an example signaling flow 300 of a transmission of frame to end TXOP according to some example embodiments of the present disclosure. For the purpose of discussion, the signaling flow 300 will be described with reference to FIG. 1. The signaling flow 300 involves the first apparatus 110 and the second apparatus 120 in FIG. 1.

The second apparatus 120 transmits (3010) a frame to end a TXOP to the first apparatus 110. That is, the first apparatus 110 receives (3010) the frame to end the TXOP from the second apparatus. For example, the frame to end the TXOP may be a contention free (CF)_END frame. The frame to end the TXOP at least includes a first frame check sequence (FCS) field (also referred to as intermediate FCS field), a padding field and a second frame check sequence field. In some example embodiments, the field FCS field and the padding field are located before the second FCS field. In some example embodiments, a physical (PHY) header in the frame to end the transmission opportunity indicates a presence of the first FCS field.

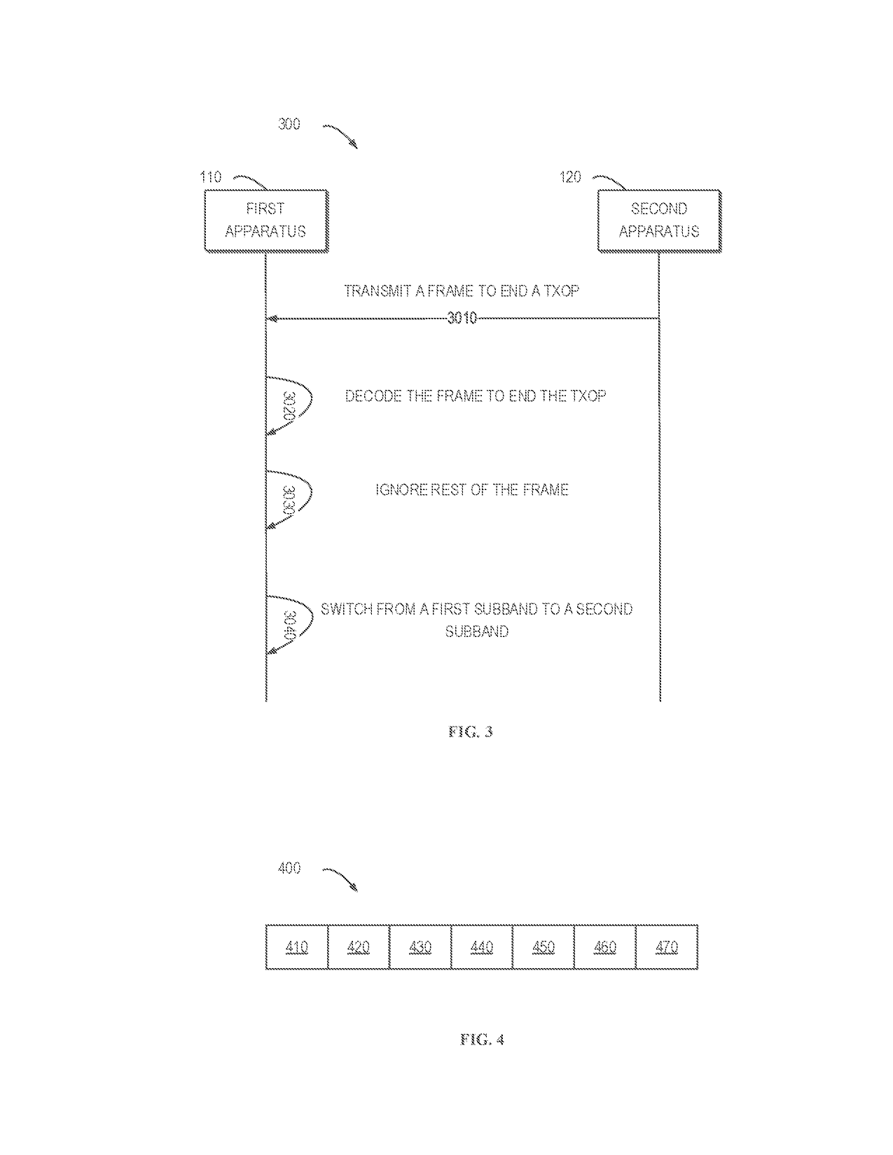

FIG. 4 illustrates a schematic diagram of an example of frame format 400 in accordance with some example embodiments of the present disclosure. The frame format 400 includes a frame control field 410, a duration field 420, a receiver address field 430, a basic service set identifier field 440, an FCS field 450 (i.e., the first FCS field), a padding field 460 and an FCS field 470 (i.e., the second FCS field).

In some example embodiments, the frame control field 410 may be 2 octets long. The frame control field 410 may include a frame type. In this case, the frame type of the frame may be control frame and its subtype is CF_end frame. Alternatively, or in addition, the duration field 420 may be 2 octets long. The receiver address field 430 may be 6 octets long. In some example embodiments, the receiver address field 430 may a broadcast address. In some other example embodiments, the basic service set identifier (BSSID) field 440 may be 6 octets long and may include the BSSID of the second apparatus 120.

In some example embodiments, the length of the FCS field 450 may be same as that of the FCS field 470. For example, the length of the FCS field 450 may be 4 octets. Alternatively, the length of the FCS field 450 may be different to that of the FCS field 470. In some example embodiments, a length of the FCS field 450 may be predefined.

The length of the padding field 460 may be variable. For example, the padding field may be long enough to cover the switching time of the first apparatus 110. In some example embodiments, a length of the padding field is larger than or equal to a predefined value. The predefined value may be any suitable value. Alternatively, the length of the padding field 460 may be determined by the second apparatus. In some example embodiments, the length of the padding field is large enough so that the first apparatus 110 operating on DSO subbands can switch back to the primary subband within a time period (for example 72 us) after the end of the frame to end the TXOP without losing medium synchronization. In this way, it can avoid the first apparatus 110 losing medium synchronization.

In some example embodiments, a sum of length of the frame and a predefined time length is no longer than remaining length of the TXOP. For example, if the sum of length of the frame and the predefined time length is longer than remaining length of the TXOP, the frame at least comprising the first frame check sequence field, the padding field and the second frame check sequence field is unapplicable. By way of example, the frame format 400 is not applied, if the total length of the frame and the predefined time length (i.e., the CF-END+padding+72us) is longer than the remaining TXOP length.

Referring back to FIG. 3, the first apparatus 110 may decode (3020) the frame to end the transmission opportunity using an FCS in the first FCS field. The first apparatus 110 may ignore (3030) rest of the frame.

The first apparatus 110 switches (3040) from a first subband to a second subband after decoding the first FCS field. The first subband may be a dynamic subband operation subband and the second subband may be a primary subband. For example, as shown in FIG. 2, if the channel 201 is the primary channel and the first apparatus 110 is operating on channel 203, the first apparatus 110 may immediately switch from the channel 203 to the channel 201. It is noted that the first subband and the second subband may be any proper subbands in the DSO. In other words, the first apparatus 110 knows to use the intermediate FCS to decode the frame up until that point, ignores the rest of the frame, and immediately switches back to the primary subband.

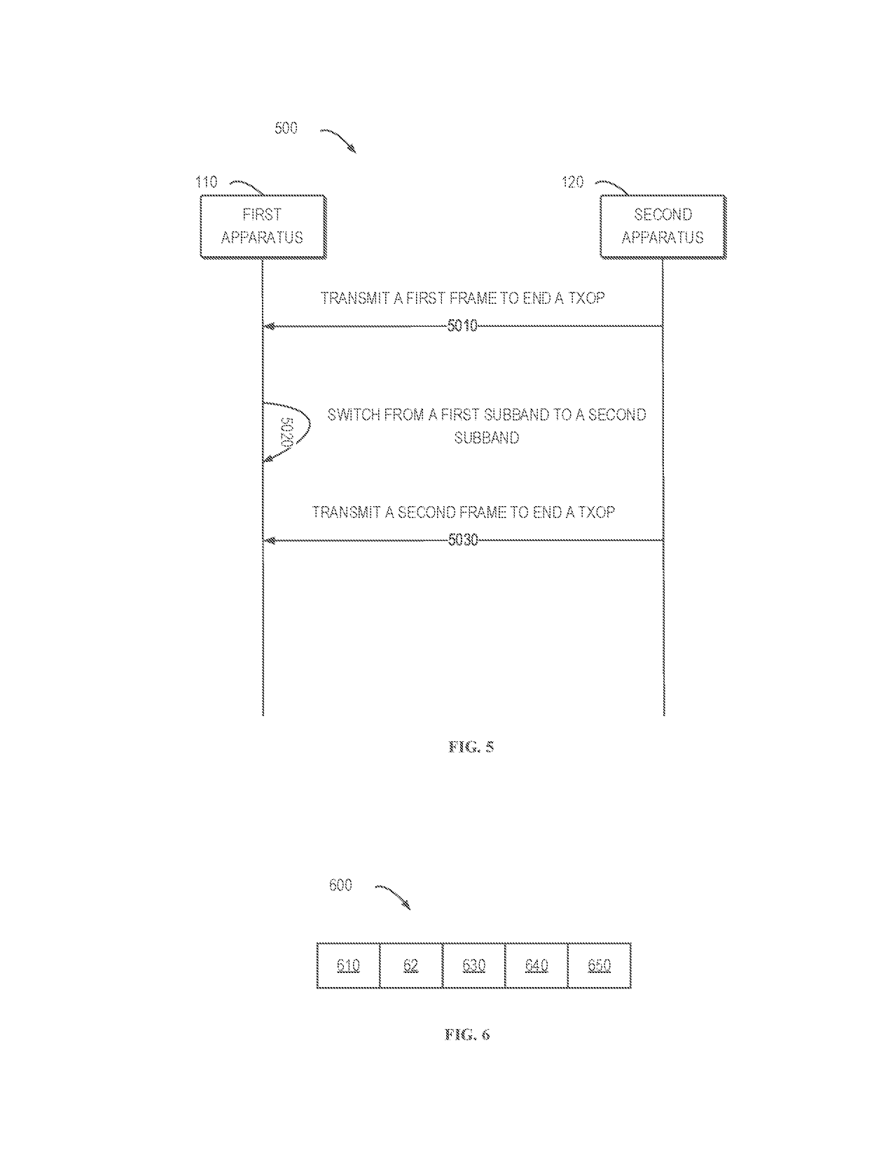

FIG. 5 illustrates an example signaling flow 500 of a transmission of frame to end TXOP according to some example embodiments of the present disclosure. For the purpose of discussion, the signaling flow 500 will be described with reference to FIG. 1. The signaling flow 500 involves the first apparatus 110 and the second apparatus 120 in FIG. 1.

The second apparatus 120 transmits (5010), to the first apparatus 110, a first frame including information reserved for/addressed to one or more apparatuses that are in a DSO within a TXOP. That is, the first apparatus 110 receives (5010), from the second apparatus 120, the first frame. In some example embodiments, the information addressed to the one or more apparatuses may include a DSO specific medium access control address. The first frame may also referred to as “CF-end announcement frame.”

FIG. 6 illustrates a schematic diagram of an example of frame format 600 in accordance with some example embodiments of the present disclosure. The frame format 600 includes a frame control field 610, a duration field 620, a receiver address field 630, a basic service set identifier field 640, and an FCS field 650.

In some example embodiments, the frame control field 610 may be 2 octets long. The frame control field 610 may include a frame type. In this case, the frame type of the frame may be control frame and its subtype is CF_end frame. Alternatively, or in addition, the duration field 620 may be 2 octets long. The receiver address field 630 may be 6 octets long. In some example embodiments, the information addressed to the one or more apparatuses may be inserted into the receiver address field 630. For example, the DSO specific medium access control address may be included in the receiver address field 630.

In some other example embodiments, the basic service set identifier (BSSID) field 640 may be 6 octets long and may include the BSSID of the second apparatus 120. In some example embodiments, the length of the FCS field 650 may be 4 octets.

The first apparatus 110 switches (5020) from a first subband to a second subband based on the reception of the first frame. The first subband may be a dynamic subband operation subband and the second subband may be a primary subband which includes the primary channel of the BSS. It is noted that the first subband and the second subband may be any proper subbands in the DSO. For example, as shown in FIG. 2, if the channel 201 is the primary channel and the first apparatus 110 is operating on channel 204, the first apparatus 110 may immediately switch from the channel 204 to the channel 201 after receiving the first frame. In this way, the first apparatus is provided with enough time to return to the primary sub-band before the TXOP ends. Further, it can prevent the first apparatus from losing medium synchronization.

The second apparatus 120 transmits (5030) a second frame to end the TXOP. In some example embodiments, the first apparatus 110 may also receive (5030) the second frame from the second apparatus 120. For example, a time duration between the first frame and the second frame is longer than or equal to the switching time from the DSO subband to the primary channel, so that t the first apparatus 110 operating on DSO subbands can switch back to the primary subband after the end of the second frame or at least within a time period (for example 72 us) after the end of the second frame without losing medium synchronization.

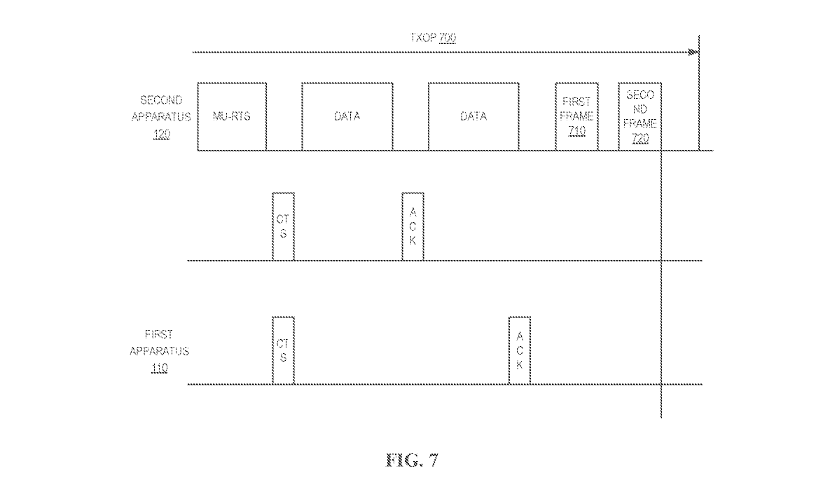

FIG. 7 illustrates a schematic diagram of a transmission of frame to end TXOP in accordance with some example embodiments of the present disclosure.

The second apparatus 120 may broadcast a multi user (MU) request to send (RTS) frame to one or more first apparatuses. The first apparatus 110 and other first apparatus may transmit a clear to send frame to the second apparatus 120. The second apparatus 120 may then transmit data frames. The first apparatus 110 and other first apparatus may transmit acknowledgements (ACKs) to the second apparatus 120. The second apparatus 120 may transmit the first frame 710 (i.e., the CF_end announcement frame) to the first apparatus 110. After receiving the first frame, the first apparatus 110 may return from the DSO subband to the primary subband. The second apparatus 120 may also broadcast the second frame 720 to end the TXOP 700. All first apparatuses are back in the primary subband after the end of the second frame or at least within a time period (for example 72 us) after the end of the second frame without losing medium synchronization.

FIG. 8 shows a flowchart of an example method 800 implemented at a first apparatus in accordance with some example embodiments of the present disclosure. For the purpose of discussion, the method 800 will be described from the perspective of the first apparatus 110 in FIG. 1.

At block 810, the first apparatus receives, from a second apparatus in the wireless network, a frame to end a transmission opportunity, TXOP, at least comprising: a first frame check sequence field, a padding field and a second frame check sequence field. One or more apparatuses including the first apparatus are in a dynamic subband operation within the TXOP.

At block 820, the first apparatus switches from a first subband to a second subband after decoding the first frame check sequence field.

In some example embodiments, a length of the padding field is larger than or equal to a predefined value.

In some example embodiments, the first frame check sequence field and the padding field are located before the second frame check sequence field.

In some example embodiments, a physical header in the frame to end the transmission opportunity indicates a presence of the first frame check sequence field.

In some example embodiments, a length of the first frame check sequence field is predefined.

In some example embodiments, the first subband is a dynamic subband operation subband and the second subband is a primary subband.

In some example embodiments, the frame further comprises: a frame control field, a duration field, a receiver address field, and a basic service set identifier field.

In some example embodiments, the receiver address field comprises a broadcast address.

In some example embodiments, a sum of length of the frame and a predefined time length is no longer than remaining length of the TXOP.

In some example embodiments, the method 800 further comprises: decoding the frame to end the transmission opportunity using a frame check sequence in the first frame check sequence field; ignoring rest of the frame; and switching from the first subband to the second subband.

In some example embodiments, in response to a sum of length of the frame and a predefined time length is longer than remaining length of the TXOP, the frame at least comprising the first frame check sequence field, the padding field and the second frame check sequence field is unapplicable.

In some example embodiments, the first apparatus comprises a terminal device within the wireless network, and the second apparatus comprises an access point within the wireless network.

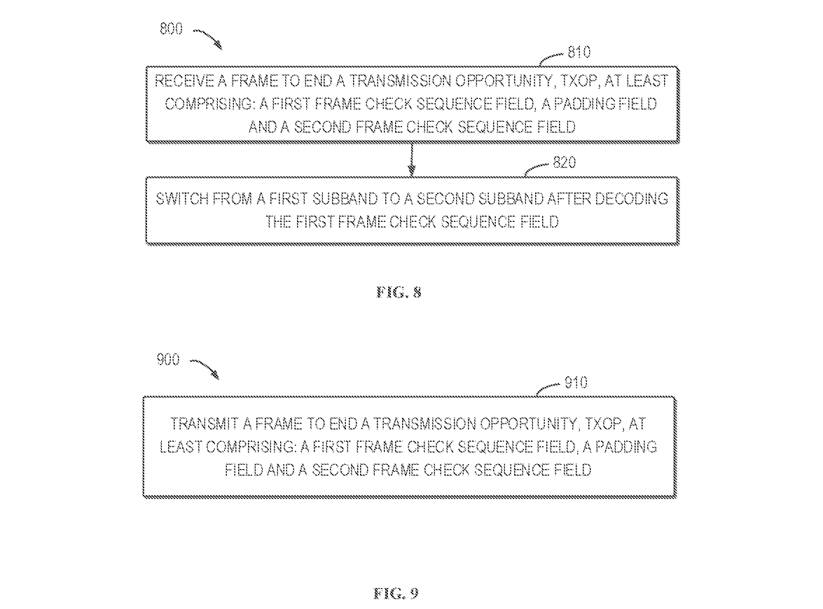

FIG. 9 shows a flowchart of an example method 900 implemented at a second apparatus in accordance with some example embodiments of the present disclosure. For the purpose of discussion, the method 900 will be described from the perspective of the second apparatus 120 in FIG. 1.

At block 910, the second apparatus transmits, to a first apparatus in the wireless network, a frame to end a transmission opportunity, TXOP, at least comprising: a first frame check sequence field, a padding field and a second frame check sequence field. One or more apparatuses including the first apparatus are in a dynamic subband operation within the TXOP.

In some example embodiments, a length of the padding field is larger than or equal to a predefined value. In some example embodiments, the length of the padding field is large enough so that STA operating on DSO subbands can switch back to the primary subband within a time period (for example 72 us) after the end of the frame to end the TXOP without losing medium synchronization.

In some example embodiments, the first frame check sequence field and the padding field are located before the second frame check sequence field.

In some example embodiments, a physical header in the frame to end the transmission opportunity indicates a presence of the first frame check sequence field.

In some example embodiments, a length of the first frame check sequence field is predefined.

In some example embodiments, the first subband is a dynamic subband operation subband and the second subband is a primary subband.

In some example embodiments, the frame further comprises: a frame control field, a duration field, a receiver address field, and a basic service set identifier field.

In some example embodiments, the receiver address field comprises a broadcast address.

In some example embodiments, a sum of length of the frame and a predefined time length is no longer than remaining length of the TXOP.

In some example embodiments, in response to a sum of length of the frame and a predefined time length is longer than remaining length of the TXOP, the frame at least comprising the first frame check sequence field, the padding field and the second frame check sequence field is unapplicable.

In some example embodiments, the first apparatus comprises a terminal device within the wireless network, and the second apparatus comprises an access point within the wireless network.

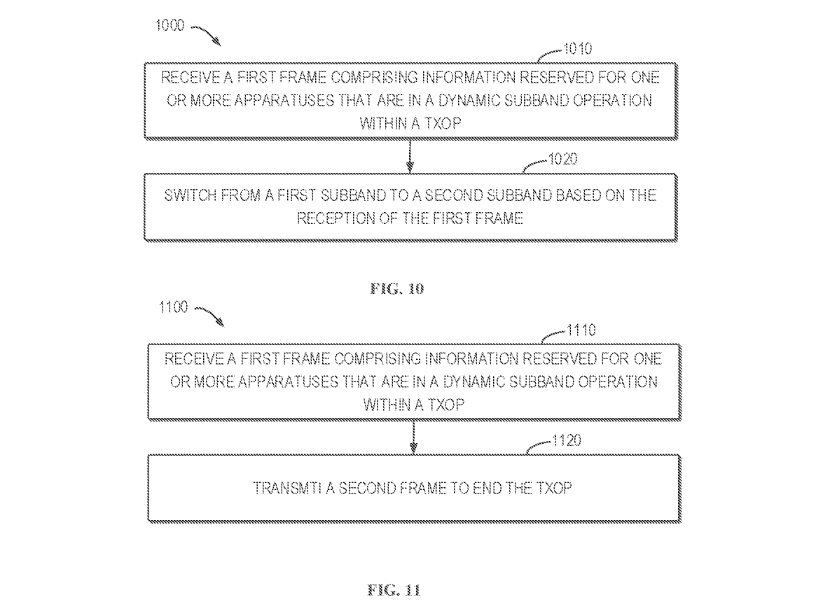

FIG. 10 shows a flowchart of an example method 1000 implemented at a first apparatus in accordance with some example embodiments of the present disclosure. For the purpose of discussion, the method 1000 will be described from the perspective of the first apparatus 110 in FIG. 1.

At block 1010, the first apparatus receives, from a second apparatus in the wireless network, a first frame comprising information addressed to one or more apparatuses that are in a dynamic subband operation within a transmission opportunity, TXOP.

At block 1020, the first apparatus switches from a first subband to a second subband based on the reception of the first frame.

In some example embodiments, the information addressed to the one or more apparatuses comprises a dynamic subband operation specific medium access control address.

In some example embodiments, the first frame comprises: a frame control field, a duration field, a receiver address field, a basic service set identifier field, and a frame check sequence field.

In some example embodiments, the information addressed to the one or more apparatuses is comprised in the receiver address field.

In some example embodiments, the first subband is a dynamic subband operation subband and the second subband is a primary subband.

In some example embodiments, the method 1000 further comprises: receiving, from the second apparatus, a second frame to end the TXOP, wherein a time duration between the first frame and the second frame is longer than or equal to a time threshold. For example, the time duration between the first frame and the second frame is long enough so that the first apparatus switching from the first subband to the second subband does not lose medium synchronization. By way of example, the time duration may be switching time from the first subband to the second subband.

In some example embodiments, the first apparatus comprises a terminal device within the wireless network, and the second apparatus comprises an access point within the wireless network.

FIG. 11 shows a flowchart of an example method 1100 implemented at a second apparatus in accordance with some example embodiments of the present disclosure. For the purpose of discussion, the method 1100 will be described from the perspective of the second apparatus 120 in FIG. 1.

At block 1110, the second apparatus transmits, to a first apparatus, a first frame comprising information addressed to one or more apparatuses that are in a dynamic subband operation within a transmission opportunity, TXOP.

At block 1120, the second apparatus transmits a second frame to end the TXOP.

In some example embodiments, the information addressed to the one or more apparatuses comprises a dynamic subband operation specific medium access control address.

In some example embodiments, the first frame comprises: a frame control field, a duration field, a receiver address field, a basic service set identifier field, and a frame check sequence field.

In some example embodiments, the information addressed to the one or more apparatuses is comprised in the receiver address field.

In some example embodiments, the first subband is a dynamic subband operation subband and the second subband is a primary subband.

In some example embodiments, a time duration between the first frame and the second frame is longer than or equal to a time threshold.

In some example embodiments, the first apparatus comprises a terminal device within the wireless network, and the second apparatus comprises an access point within the wireless network.

In some example embodiments, a first apparatus capable of performing any of the method 800 (for example, the first apparatus 110 in FIG. 1) may comprise means for performing the respective operations of the method 800. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus in the wireless network, a frame to end a transmission opportunity, TXOP, at least comprising: a first frame check sequence field, a padding field and a second frame check sequence field, wherein one or more apparatuses including the first apparatus are in a dynamic subband operation within the TXOP; and means for switching from a first subband to a second subband after decoding the first frame check sequence field.

In some example embodiments, a length of the padding field is larger than or equal to a predefined value.

In some example embodiments, the first frame check sequence field and the padding field are located before the second frame check sequence field.

In some example embodiments, a physical header in the frame to end the transmission opportunity indicates a presence of the first frame check sequence field.

In some example embodiments, a length of the first frame check sequence field is predefined.

In some example embodiments, the first subband is a dynamic subband operation subband and the second subband is a primary subband.

In some example embodiments, the frame further comprises: a frame control field, a duration field, a receiver address field, and a basic service set identifier field.

In some example embodiments, the receiver address field comprises a broadcast address.

In some example embodiments, a sum of length of the frame and a predefined time length is no longer than remaining length of the TXOP.

In some example embodiments, the first apparatus further comprises: means for decoding the frame to end the transmission opportunity using a frame check sequence in the first frame check sequence field; means for ignoring rest of the frame; and means for switching from the first subband to the second subband.

In some example embodiments, in response to a sum of length of the frame and a predefined time length is longer than remaining length of the TXOP, the frame at least comprising the first frame check sequence field, the padding field and the second frame check sequence field is unapplicable.

In some example embodiments, the first apparatus comprises a terminal device within the wireless network, and the second apparatus comprises an access point within the wireless network.

In some example embodiments, a second apparatus capable of performing any of the method 900 (for example, the second apparatus 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus in the wireless network, a frame to end a transmission opportunity, TXOP, at least comprising: a first frame check sequence field, a padding field and a second frame check sequence field, wherein one or more apparatuses including the first apparatus are in a dynamic subband operation within the TXOP.

In some example embodiments, a length of the padding field is larger than or equal to a predefined value.

In some example embodiments, the first frame check sequence field and the padding field are located before the second frame check sequence field.

In some example embodiments, a physical header in the frame to end the transmission opportunity indicates a presence of the first frame check sequence field.

In some example embodiments, a length of the first frame check sequence field is predefined.

In some example embodiments, the first subband is a dynamic subband operation subband and the second subband is a primary subband.

In some example embodiments, the frame further comprises: a frame control field, a duration field, a receiver address field, and a basic service set identifier field.

In some example embodiments, the receiver address field comprises a broadcast address.

In some example embodiments, a sum of length of the frame and a predefined time length is no longer than remaining length of the TXOP.

In some example embodiments, in response to a sum of length of the frame and a predefined time length is longer than remaining length of the TXOP, the frame at least comprising the first frame check sequence field, the padding field and the second frame check sequence field is unapplicable.

In some example embodiments, the first apparatus comprises a terminal device within the wireless network, and the second apparatus comprises an access point within the wireless network.

In some example embodiments, a first apparatus capable of performing any of the method 1000 (for example, the first apparatus 110 in FIG. 1) may comprise means for performing the respective operations of the method 1000. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus in the wireless network, a first frame comprising information addressed to one or more apparatuses that are in a dynamic subband operation within a transmission opportunity, TXOP; and means for switching from a first subband to a second subband based on the reception of the first frame.

In some example embodiments, the information addressed to the one or more apparatuses comprises a dynamic subband operation specific medium access control address.

In some example embodiments, the first frame comprises: a frame control field, a duration field, a receiver address field, a basic service set identifier field, and a frame check sequence field.

In some example embodiments, the information addressed to the one or more apparatuses is comprised in the receiver address field.

In some example embodiments, the first subband is a dynamic subband operation subband and the second subband is a primary subband.

In some example embodiments, the first apparatus further comprises: means for receiving, from the second apparatus, a second frame to end the TXOP, wherein a time duration between the first frame and the second frame is longer than or equal to a time threshold.

In some example embodiments, the first apparatus comprises a terminal device within the wireless network, and the second apparatus comprises an access point within the wireless network.

In some example embodiments, a second apparatus capable of performing any of the method 1100 (for example, the second apparatus 120 in FIG. 1) may comprise means for performing the respective operations of the method 1100. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a first frame comprising information addressed to one or more apparatuses that are in a dynamic subband operation within a transmission opportunity, TXOP; and means for transmitting a second frame to end the TXOP.

In some example embodiments, the information addressed to the one or more apparatuses comprises a dynamic subband operation specific medium access control address.

In some example embodiments, the first frame comprises: a frame control field, a duration field, a receiver address field, a basic service set identifier field, and a frame check sequence field.

In some example embodiments, the information addressed to the one or more apparatuses is comprised in the receiver address field.

In some example embodiments, the first subband is a dynamic subband operation subband and the second subband is a primary subband.

In some example embodiments, a time duration between the first frame and the second frame is longer than or equal to a time threshold.

In some example embodiments, the first apparatus comprises a terminal device within the wireless network, and the second apparatus comprises an access point within the wireless network.

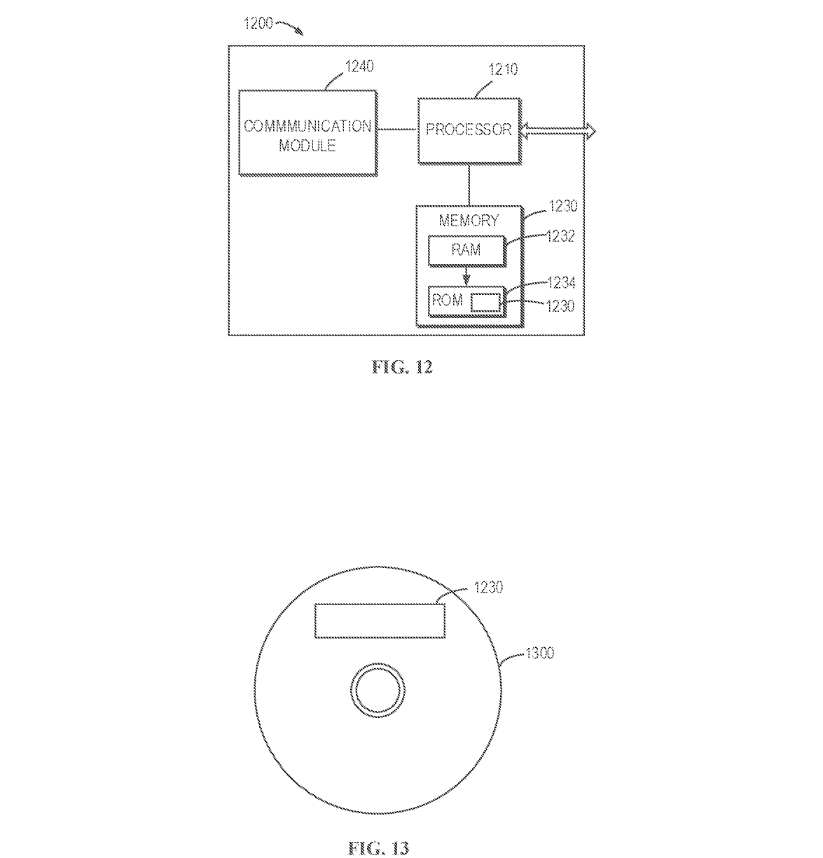

FIG. 12 is a simplified block diagram of a device 1200 that is suitable for implementing example embodiments of the present disclosure. The device 1200 may be provided to implement a communication device, for example, the first apparatus 110 or the second apparatus 120 as shown in FIG. 1. As shown, the device 1200 includes one or more processors 1210, one or more memories 1220 coupled to the processor 1210, and one or more communication modules 1240 coupled to the processor 1210.

The communication module 1240 is for bidirectional communications. The communication module 1240 has one or more communication interfaces to facilitate communication with one or more other modules or devices. The communication interfaces may represent any interface that is necessary for communication with other network elements. In some example embodiments, the communication module 1240 may include at least one antenna.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 1222 and other volatile memories that will not last in the power-down duration.

A computer program 1230 includes computer executable instructions that are executed by the associated processor 1210. The instructions of the program 1230 may include instructions for performing operations/acts of some example embodiments of the present disclosure. The program 1230 may be stored in the memory, e.g., the ROM 1224. The processor 1210 may perform any suitable actions and processing by loading the program 1230 into the RAM 1222.

The example embodiments of the present disclosure may be implemented by means of the program 1230 so that the device 1200 may perform any process of the disclosure as discussed with reference to FIGS. 3 to 11. The example embodiments of the present disclosure may also be implemented by hardware or by a combination of software and hardware.

In some example embodiments, the program 1230 may be tangibly contained in a computer readable medium which may be included in the device 1200 (such as in the memory 1220) or other storage devices that are accessible by the device 1200. The device 1200 may load the program 1230 from the computer readable medium to the RAM 1222 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 13 shows an example of the computer readable medium 1300 which may be in form of CD, DVD or other optical storage disk. The computer readable medium 1300 has the program 1230 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus in a wireless network to:
receive, from a second apparatus in the wireless network, a first frame comprising information addressed to one or more apparatuses that are in a dynamic subband operation within a transmission opportunity, TXOP; and
switch from a first subband to a second subband based on the reception of the first frame.

2. The first apparatus of claim 1, wherein the information addressed to the one or more apparatuses comprises a dynamic subband operation specific medium access control address.

3. The first apparatus of claim 1, wherein the first frame comprises:
a frame control field,
a duration field,
a receiver address field,
a basic service set identifier field, and
a frame check sequence field.

4. The first apparatus of claim 3, wherein the information addressed to the one or more apparatuses is comprised in the receiver address field.

5. The first apparatus of claim 1, wherein the first subband is a dynamic subband operation subband and the second subband is a primary subband.

6. The first apparatus of claim 1, wherein the first apparatus is caused to:
receive, from the second apparatus, a second frame to end the TXOP, wherein a time duration between the first frame and the second frame is longer than or equal to accommodate the switching of the first apparatus first subband to the second subband without losing synchronization to the medium on the second subband.

7. The first apparatus of claim 1, wherein the first apparatus comprises a terminal device within the wireless network, and the second apparatus comprises an access point within the wireless network.

8. A second apparatus comprising:
at least one processor; and
at least one memory storing instructions that, when executed by the at least one processor, cause the second apparatus in a wireless network to:
transmit, to a first apparatus, a first frame comprising information addressed to one or more apparatuses that are in a dynamic subband operation within a transmission opportunity, TXOP; and
transmit a second frame to end the TXOP.

9. The second apparatus of claim 8, wherein the information addressed to the one or more apparatuses comprises a dynamic subband operation specific medium access control address.

10. The second apparatus of claim 8, wherein the first frame comprises:
a frame control field,
a duration field,
a receiver address field,
a basic service set identifier field, and
a frame check sequence field.

11. The second apparatus of claim 10, wherein the information addressed to the one or more apparatuses is comprised in the receiver address field.

12. The second apparatus of claim 8, wherein the first subband is a dynamic subband operation subband and the second subband is a primary subband.

13. The second apparatus of claim 8, wherein a time duration between the first frame and the second frame is longer than or equal to a time threshold.

14. The second apparatus of claim 8, wherein the first apparatus comprises a terminal device within the wireless network, and the second apparatus comprises an access point within the wireless network.

15. A method comprising:
receiving, at a first apparatus and from a second apparatus, a first frame comprising information addressed to one or more apparatuses that are in a dynamic subband operation within a transmission opportunity, TXOP; and
switching from a first subband to a second subband based on the reception of the first frame.

16. A method comprising:
transmitting, at a second apparatus and to a first apparatus, a first frame comprising information addressed to one or more apparatuses that are in a dynamic subband operation within a transmission opportunity, TXOP; and
transmitting a second frame to end the TXOP.

17. A computer readable medium comprising instructions stored thereon for causing an apparatus at least to perform the method comprising:
receiving, from a second apparatus, a first frame comprising information addressed to one or more apparatuses that are in a dynamic subband operation within a transmission opportunity, TXOP; and
switching from a first subband to a second subband based on the reception of the first frame.

18. A computer readable medium comprising instructions stored thereon for causing an apparatus at least to perform the method comprising:
transmitting, to a first apparatus, a first frame comprising information addressed to one or more apparatuses that are in a dynamic subband operation within a transmission opportunity, TXOP; and
transmitting a second frame to end the TXOP.
